(19) United States
(12) Patent Application Publication
(10) Pub. No.: US 2017/0341089 A1
(43) Pub. Date: Nov. 30, 2017

(54) QUICK-CHANGE NOZZLE, ASSOCIATED NOZZLE QUICK-CHANGE SYSTEM AND ASSOCIATED APPLICATION SYSTEM

(71) Applicant: Dürr Systems AG, Bietigheim-Bissingen (DE)

(72) Inventors: Bernd Kraft, Steinheim-Höpfigheim (DE); Martin Stiegler, Beilstein (DE); Herbert Martin, Weinstadt-Grossheppach (DE); Lothar Rademacher, Bietigheim-Bissingen (DE); Werner Schwager, Ludwigsburg (DE)

(21) Appl. No.: 15/532,259

(22) PCT Filed: Dec. 2, 2015
(86) PCT No.: PCT/EP2015/002418

§ 371 Date: Jun. 1, 2017

(30) Foreign Application Priority Data
Dec. 3, 2014 (DE) 10 2014 017 856.0

(51) Int. Cl. B05B 1/04; B05B 13/04; F16L 37/23

(52) U.S. Cl. CPC B05B 1/04; B05B 13/0431; F16L 37/23

(57) ABSTRACT

An interchangeable nozzle is provided), in particular a quick-change nozzle for applying an application agent onto a component and for fastening to a nozzle change system. The nozzle includes a nozzle body having an alignment feature for the angularly correct, mechanical alignment of the nozzle on the change system. The present disclosure also relates to an associated change system and to an associated application system.

### CROSS-REFERENCE TO RELATED APPLICATIONS

This application is a national stage of, and claims priority to, Patent Cooperation Treaty Application No. PCT/EP2015/002418, filed on Dec. 2, 2015, which application claims priority to German Application No. DE 10 2014 017 856.0, filed on Dec. 3, 2014, which applications are hereby incorporated herein by reference in their entireties.

### BACKGROUND

The present disclosure relates to an interchangeable nozzle, in particular to a quick-change nozzle, for applying an application agent onto a component, to an associated change system, in particular a nozzle quick-change system, and to an associated application system.

With respect to the general prior art, reference can be made initially to DE 200 10 075 U1.

In particular, nozzles for applying a sealing material for seam-sealing of motor vehicle body components must be changed at regular intervals, e.g. for reasons relating to wear or because a change in intended use necessitates a different nozzle. A tool change system is known from DE 10 2007 038 791 A1. Such a change system comprises a discharge nozzle part having a robot-side main part and a discharge nozzle part connected thereto. The discharge nozzle part comprises a nozzle and is connected to the main part in a releasable manner via a coupling system, in particular a bayonet fitting. Such a change system may have a relatively bulky design. The nozzle can be changed in two ways. In one case, the nozzle is removed together with the discharge nozzle part. In the other case, the discharge nozzle part is unscrewed with a screwdriver, a clamping plate is removed and then the nozzle is removed.

### SUMMARY

The present disclosure provides an option for changing a nozzle in which a first nozzle can be removed quickly and another nozzle likewise can be mounted quickly with correct alignment and, in some implementations, without the need for an additional screwing tool and/or without the need to disassemble another part as the nozzle to be changed. Alternatively or in addition, the present disclosure provides a compact, in particular a flatly constructed, change system.

The present disclosure provides an interchangeable nozzle, in particular a quick-change nozzle, for applying an application agent (e.g. sealant, adhesive material, preserving agent, in particular wax, synthetic material, etc.) onto a component (e.g. a motor vehicle body and/or attachment part therefor) and for fastening to a change system.

The nozzle is used in particular for producing seals (e.g. seam seals or flanged seam seals), adhesive bonds, protective films, insulating elements and/or visible seams and in particular, e.g., on motor vehicle bodies and/or attachment parts therefor. Alternatively or in addition, the nozzle can be used for preserving, in particular preserving cavities of, motor vehicle bodies. The change system is mounted, in some implementations, on an application block which is described further hereinafter and can be designed e.g. as having a 3D gun configuration.

The nozzle comprises a nozzle body with a shape including an alignment feature configured to provide mechanical alignment of the nozzle on the change system, which alignment is defined angularly relative to the longitudinal and/or central axis of the nozzle. The alignment feature corresponds to mechanical coding, whereby the nozzle can only be mounted on the change system if it is aligned in the correct orientation.

In some implementations, the alignment feature includes a non-circular and/or rotationally asymmetrical outer shape or geometry of the nozzle. In some such implementations, the outer shape or geometry comprises at least one alignment portion, which is formed on the side of the nozzle, for the angularly correct, mechanical alignment. The alignment portion, in some implementations, independently provides for the outer shape or geometry of the nozzle to be rotationally asymmetrical and/or is non-circular.

The alignment portion is, in some implementations, linear and/or planar, e.g. flattened, on the outer surface of the nozzle, in order to produce a rotationally asymmetrical outer geometry that is non-circular at least in portions. The alignment portion, in some implementations, is a linear and/or planar indentation which extends along the outer surface of the nozzle body. The alignment portion of the nozzle, in some implementations, serves for the contour-parallel alignment on the change system, in particular on the alignment feature of the change system.

In some implementations, the outer geometry of the nozzle is formed in a round manner in portions and in a planar manner in portions.

The nozzle body further includes one or a plurality of holding recesses in the nozzle body for releasably holding the nozzle on the change system.

The at least one holding recess is, in some implementations, conical and/or tapered into the nozzle interior, e.g. with stepped diameters. As such, a non-axial, e.g. substantially radial, loading of the holding recess or in general of the nozzle may cause an axial displacement of the nozzle, e.g. in order to press the nozzle axially against a sealing element and/or a spring element.

In some implementations, the at least one holding recess is in the form of a holding groove and extends, e.g., annularly or, at least in portions, arcuately around the nozzle. With such a configurations, the at least one holding recess may provide that the nozzle is fixed substantially free of clearance in the axial direction, whereas the alignment featureshape may provide that the nozzle is fixed substantially free of clearance in the circumferential direction.

In some implementations, the alignment feature of the nozzle includes at least two holding recesses which are spaced apart from one another in the circumferential direction of the nozzle so that the holding recesses allow the nozzle to be fixed only in an angularly correct, mechanical alignment. The holding recesses additionally serve to releasably hold the nozzle on the change system. As a result, the alignment feature can provide for alignment of the nozzle and releasably holding the nozzle on the change system. For example, in such implementations, as the two holding recesses are spaced apart from one another in the circumferential direction of the nozzle, the nozzle can be mounted on the change system only in a predetermined and therefore angularly correct alignment. Therefore, in this implementation the holding recesses, in some implementations, ensure that the nozzle is fixed substantially free of clearance in the axial direction and in the circumferential direction.

The nozzle body comprises, in some implementations, two portions, specifically a fastening base and a nozzle head.

In some implementations, the fastening base includes the alignment feature and/or the at least one holding recess.

The fastening base is designed, in some implementations, as a centring pin having, at least in portions, a circular outer contour to be received in the change system.

In some implementations, a step offset is formed between the nozzle head and fastening base and can be used e.g. for abutment on the change system.

The nozzle head is, in some implementations, broader than the fastening base and has in particular a larger outer diameter than the fastening base.

The nozzle can be e.g. a slot nozzle (e.g. a flat stream nozzle) and therefore can have a slot-shaped nozzle outlet opening. However, other nozzles and nozzle outlet openings are also possible (e.g. hem flange, airless, extrusion, circular jet, etc.).

The nozzle is used in particular for producing seals (e.g. seam seals), adhesive bonds, insulating elements and/or protective films on motor vehicle bodies and/or attachment parts thereof. Alternatively or in addition, the nozzle can be used for preserving, in particular preserving cavities of, motor vehicle bodies.

The present disclosure also provides a change system, in particular a nozzle quick-change system, for an interchangeable nozzle such as disclosed herein. The change system can be designed as a rotary or push change system. The change system is used for mounting on an application block (e.g. a 3D gun) which is typically fastened to a lance which can rotate about its longitudinal axis.

The change system is, in some implementations, a quick-change system which requires a change of the nozzle without the need for a screwing tool and/or without the need for removing another part as the nozzle. For example, in some implementations, with a rotational or pushing movement of the change system, the nozzle can be fixed or released for removal. The rotational movement required for this purpose can be e.g. less than 45°, the required pushing movement can be e.g. less than 2 cm.

It should be understood that the nozzle, as disclosed herein, and the change system, as disclosed herein, are designed in a complementary manner, so that the nozzle can be mounted on the change system. Therefore, the description relating to the corresponding features of each of the nozzle and the change system applies in a complementary manner to the other of the nozzle and the change system.

The change system comprises an alignment feature for the mechanical alignment of the nozzle, which alignment is angularly correct in particular in relation to the longitudinal and/or central axis of the nozzle.

The alignment feature of the change system includes at least one planar and/or linear alignment portion for the contour-parallel alignment of the nozzle. The alignment portion is arranged, in some implementations, on an inlet opening of the change system, e.g. such that the inlet opening is provided with at least, in portions, a non-circular inner contour. In some implementations, the inner contour of the inlet opening is planar and/or linear, and/or rotationally non-symmetrical. In such implementations, the inlet opening is thereby configured for only a correspondingly aligned nozzle can pass through the inlet opening.

The alignment feature can comprise at least two fastening elements, which are spaced apart from one another in the circumferential direction and/or laterally and can be displaced, in some implementations, non-axially, e.g. substantially radially and/or laterally, for the purpose of holding the nozzle, so that the fastening elements allow the nozzle to be fixed only in an angularly correct alignment. The fastening elements additionally serve to releasably hold the nozzle. As a result, the alignment feature serves also as a holding feature for releasably holding the nozzle. The fastening elements can thus be used in order to assume not only the holding function but also the function of angularly correct, mechanical alignment of the nozzle because the holding recesses of the nozzle move into engagement only in a predetermined and thus angularly correct alignment with the fastening elements. Therefore, in this implementation the fastening elements, ensure that the nozzle can be fixed free of clearance in the axial direction and in the circumferential direction.

The change system comprises, in some implementations, a receptacle having a cylindrical, in particular circular-cylindrical inner contour for receiving the fastening base of the nozzle in an accurately fitting manner and/or in a centered manner, in particular free of clearance. The receptacle can have e.g. a round or square or rectangular outer contour.

The change system comprises, in some implementations, at least one inwardly and outwardly displaceable fastening element for holding the nozzle, and, in some implementations, at least one fastening element which can be displaced non-axially, in particular substantially radially, relative to the receptacle. The at least one fastening element serves in particular to press laterally externally onto the nozzle in order to hold the nozzle. The fastening element is inserted in a displaceable manner, in some implementations, in an opening of the wall of the receptacle.

In some implementations, the wall of the receptacle has at least one opening, into which a displaceable fastening element is inserted. In some implementations, the wall comprises a plurality of openings which are spaced apart from one another in the circumferential direction of the receptacle and into which a displaceable fastening element is inserted in each case.

The change system comprises a movable, and, in some implementations, rotatable actuating element or an actuating element which can be displaced in particular in a translational or linear manner and which comprises a profiled inner clamping contour for pressing and/or releasing the at least one fastening element in order to bring the nozzle to a fixed state or a released state.

The inner clamping contour is, in some implementations, formed in a profiled manner such that the actuating element is held in a self-locking manner in the fixing position in order to fix the nozzle.

The at least one fastening element can be moved inwardly, in some implementations, with the actuating element in order to be pressed laterally against the nozzle. As already mentioned previously, the at least one fastening element moves, in some implementations, substantially radially and/or non-axially with respect to the receptacle of the change system.

An actuating element can be in particular a rotating lock so that the change system constitutes a rotary change system.

The rotating lock has in particular a clamping ring which comprises the inner clamping contour on the inner side.

The clamping ring surrounds the wall of the receptacle and thus consequently the at least one fastening element. By virtue of the fact that the wall is inserted into the clamping ring, in some implementations, in an accurately fitting manner, the change system is relatively compact, in particular relatively flat. The actuating element and the receptacle are not constructed one on top of the other but instead are joined one inside the other.

The rotating lock comprises at least one rotating arm which protrudes radially from the clamping ring and can be provided e.g. with a rotating flange.

In some implementations, a rotational movement of the rotating lock of less than 180°, less than 90°, less than 60°, less than 45° or even less than 30° is sufficient to bring the nozzle to a fixed state or a released state.

The change system can have a housing element. The housing element, in some implementations, has an inlet opening which has the alignment feature and via which the nozzle can be supplied to the change system for fixing purposes, however only if it is aligned in an angularly correct manner.

The housing element serves as a housing for the clamping ring and/or the receptacle.

In some implementations, the outer contour of the housing element is formed on at least one side in a curved manner in parallel with the rotational path of the rotating flange.

In some implementations, the actuating element is a pusher and/or the change system constitutes a push change system.

The pusher comprises the inner clamping contour on the inner side.

In some implementations, the pusher surrounds the wall of the receptacle, in some implementations, in an accurately fitting manner, on two or three sides. By virtue of the fact that the wall is inserted into the pusher, in some implementations, in an accurately fitting manner, the change system is relatively compact, in particular relatively flat. The actuating element and the receptacle are not constructed one on top of the other but instead are inserted one inside the other.

In the “pusher” implementation, the outer contour of the wall is, in some implementations, square or rectangular and in the “rotating lock” implementation it is, in some implementations, annular. In both implementations, the inner contour is cylindrical, in some implementations, circular-cylindrical.

In some implementations, the pusher is substantially U-shaped and comprises in particular two mutually connected arm portions, of which the inner sides have the inner clamping contour. However, the pusher does not have to have an open cross-sectional shape but can also have a closed cross-sectional shape, e.g. closed arm portions. Furthermore, the arm portions can each be provided with a long hole for guiding and/or holding the pusher.

In some implementations, the alignment feature is formed on the pusher. The alignment feature, in some implementations, defines an inlet opening for the nozzle, via which the nozzle can be supplied to the change system for fixing purposes, however only if it is aligned in an angularly correct manner.

Furthermore, the change system, in some implementations, comprises an elastic sealing element, against which the nozzle in the fixed state can be acted upon axially in an expedient manner with at least one fastening element which is displaced non-axially. The sealing element can be e.g. a sealing ring.

Moreover, the change system can have at least one spring element or another elastic element, against which the nozzle in the fixed state can be acted upon axially in an expedient manner with at least one fastening element displaced non-axially and which acts upon the nozzle in an axial manner outwards in order to assist in the removal of the nozzle.

In some implementations, the change system has a nozzle change station having a plurality of nozzles, as described herein. The nozzle change station, in some implementations, comprises a nozzle removal section where a nozzle can be automatically removed from the change system, and a nozzle delivery section where a nozzle can be automatically mounted on the change system. The nozzle removal section and the nozzle delivery section can be two mutually separate sections or can be the same section.

The nozzle change station in combination with the change system/nozzle combination, as described herein, permits, in some implementations, a completely unmanned, machine-operated and/or automatic nozzle change procedure.

The at least one fastening element is, in some implementations, a ball which is acted upon with the actuating element, in particular the inner clamping contour. Furthermore, the at least one fastening element can be a fastening element, at least portions of which are spherical or cylindrical.

In some implementations, the change system comprises at least one fastening element which is acted upon by spring and cannot be acted upon by the actuating element, in particular the inner clamping contour.

The nozzle and the change system are designed such that the nozzle head, after being mounted on the change system, protrudes from the change system and therefore is freely accessible, which facilitates the change procedure.

In some implementations, the change system can have a height of less than 3 cm or even less than 2 cm, which can be achieved in particular by the at least partial insertion of the receptacle into the rotating lock (rotating ring) or into the pusher and alternatively or in addition by the use of flat components.

In some implementations, the receptacle having the cylindrical inner contour serves for receiving the nozzle-fastening base in an accurately fitting manner.

In some implementations, the change system can be actuated manually and automatically, e.g. by machine.

The present disclosure is not restricted to a change system and a nozzle but rather also comprises an application system having an application block (e.g. a so-called 3D gun), and, in some implementations, at least two change systems as disclosed herein, as well as, in some implementations, at least two nozzles as disclosed herein and a manipulator (e.g. a robot) which carries a lance, which is rotatable about its longitudinal axis, for guiding the application block. The application system is used, in some implementations, for producing seals (e.g. seam seals, flanged seam seals, etc.), protective film applications, insulating elements and/or visible seams on motor vehicle bodies and/or attachment parts thereof. Alternatively or in addition, it can be used for preserving cavities of motor vehicle bodies.

The manipulator is, in some implementations, a robot (e.g. a multi-axis robot) but e.g. can also be hand-operated.

It should be mentioned once again that the alignment portion of the nozzle and the alignment feature of the change system serve in particular for the angularly correct, mechanical alignment of the nozzle and moreover in an expedient manner in relation to the longitudinal and/or central axis of the nozzle.

In order to be able to perform application activities (e.g. seam sealings, cavity preservation, etc.) which are to be performed in constricted spaces, the application block must be as compact as possible. Just because the change system, as disclosed herein, is constructed extremely flatly, it is possible to mount more than only one change system on the application block. In some implementations, the present disclosure also comprises implementations having only one change system.

Furthermore, the application system can comprise a nozzle change station having a plurality of nozzles, as disclosed herein. The manipulator (e.g. a robot) is configured so as to guide the application block and thus the change systems to the nozzle change station for automatically changing the nozzles, so that at or in the nozzle change station the nozzle can be changed automatically and therefore in an unmanned manner. In order to automatically change the nozzles, e.g. movements of the manipulator and/or movable actuating components of the nozzle change station can be used.

The previously described implementations and features of the present disclosure can be combined with one another.

### DRAWINGS

The present disclosure is further described herein in conjunction with the accompanying figures, in which:

FIG. 1 shows a perspective view of a nozzle according to one implementation of the present disclosure,

FIG. 2 shows an exploded perspective view of the nozzle of FIG. 1 and of an associated change system according to one implementation of the present disclosure,

FIG. 3 shows the nozzle and the change system of FIG. 2 in a mounted state,

FIG. 4 shows a sectional view according to line A-A of FIG. 3,

FIG. 5 shows a sectional view of the change system of FIGS. 2 to 4 in an open state,

FIG. 6 shows a sectional view of the change system of FIGS. 2 to 5 in a fixed state,

FIG. 7 shows an exploded perspective view of a nozzle according to one implementation of the present disclosure and of an associated change system according to one implementation of the present disclosure,

FIG. 8 shows a perspective view of the change system and of the nozzle of FIG. 7 in a mounted state,

FIG. 9 shows a sectional view of the nozzle and of the change system according to line A-A of FIG. 8,

FIG. 10 shows a sectional view according to line B-B of FIG. 8,

FIG. 11 shows a perspective exploded view of a nozzle according to one implementation of the present disclosure and of an associated change system according to one implementation of the present disclosure,

FIG. 12 shows a perspective view of the nozzle and of the change system of FIG. 11 in a mounted state,

FIG. 13 shows a sectional view according to line A-A of FIG. 12,

FIG. 14 hows a schematic view of an application system according to one implementation of the present disclosure,

FIG. 15 shows a detailed illustration of a lance which is rotatable about its longitudinal axis,

FIG. 16 shows a pressure reducer according to one implementation of the present disclosure, and

FIG. 17 shows a sectional view of a nozzle having a mixer in the application head according to one implementation of the present disclosure.

It should be understood that the implementations shown in the figures correspond to each other in part, wherein like or identical parts are designated by the same reference signs, where appropriate with an apostrophe.

### DESCRIPTION

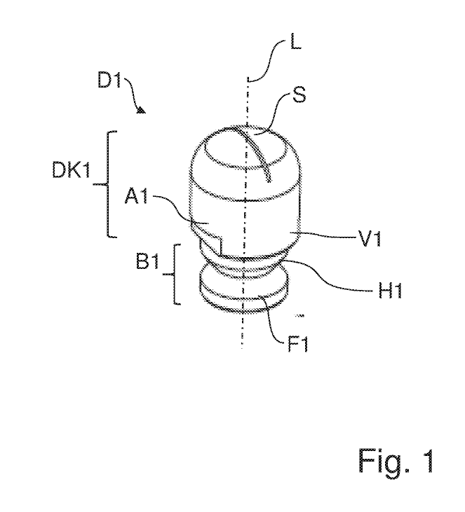

FIG. 1 shows a perspective view of a nozzle D1 according to one implementation of the present disclosure.

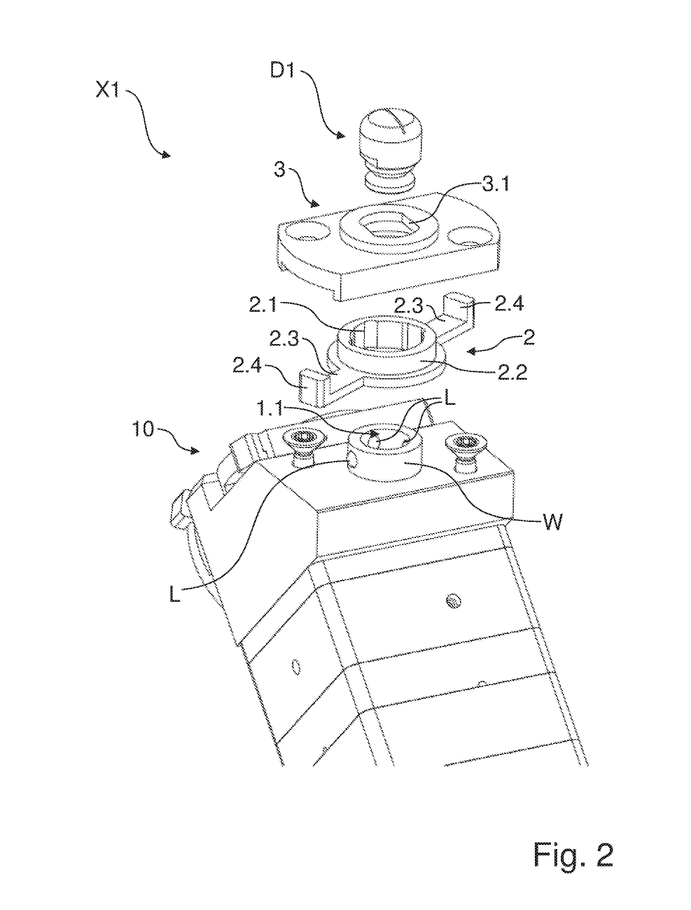

The nozzle D1 is an interchangeable nozzle for applying an application agent onto a component, e.g. a motor vehicle body, and for fastening to a change system X1 (FIGS. 2 to 6 and 11 to 13). In particular, the nozzle D1 is a slot nozzle having a slot-shaped nozzle outlet opening S for producing a seam seal on a motor vehicle body. However, the nozzle 1 can also have other nozzle outlet openings and therefore is not restricted to slot nozzles.

The interchangeable nozzle D1 is constructed as a quick-change nozzle and can be mounted on and removed from the change system X1 without any additional tool. Furthermore, the nozzle 1 can be removed from the change system X1 without the need to remove parts other than the nozzle D1 itself.

The nozzle body of the nozzle D1 comprises an alignment feature A1 for the angularly correct, mechanical alignment of the nozzle 1 on the change system X1, and a holding feature H1 for releasably holding the nozzle D1 on the change system X1.

The angularly correct alignment of the nozzle D1 relates to the longitudinal/central axis L of the nozzle D1.

An rotationally asymmetrical, non-circular outer geometry of the nozzle D1 serves as the alignment feature A1. The outer geometry comprises laterally at least one linear or planar alignment portion A1 for the angularly correct, mechanical alignment of the nozzle D1. The alignment portion A1 serves for the contour-parallel alignment on the change system X1 and for the rotationally asymmetrical formation of the outer geometry of the nozzle D1.

The holding feature H1 comprises a holding recess which is designed as a holding groove and extends in an annular manner around the nozzle D1. The holding recess is conically formed and tapers into the nozzle interior, so that a non-axial, in particular substantially radial loading of the holding recess H1 leads to an axial loading of the nozzle D1, whereby e.g. an end surface F1 of the nozzle D1 can be pressed against a, in some implementations, elastic sealing element and/or a spring element to assist in the removal of the nozzle D1.

The nozzle body is divided into a nozzle head DK1 and a fastening base B1.

The nozzle head DK1 comprises the slot-shaped nozzle outlet opening S and the alignment feature A1. The fastening base B1 comprises the holding feature H1. The fastening base B1 is designed as a centring pin having, at least in portions, a circular outer contour and is used for insertion into a receptacle of the change system X1.

The nozzle head DK1 is broader and has a larger outer diameter than the fastening base B1, so that between the nozzle head DK1 and the fastening base B1 a step offset V1 is formed which can be used for abutment on the change system X1.

FIG. 2 shows a perspective exploded view of a change system X1 according to one implementation of the present disclosure, in particular for a nozzle D1 according to FIG. 1.

The change system X1 is designed as a quick-change rotary system and thus renders it possible for the nozzle D1 to be interchangeable without the need for a screwdriver or other releasing tool and without the need for removing a part other than the nozzle D1. A rotational movement of e.g. less than 45° is sufficient to fix or release the nozzle 1. In spite of the rapid and simple change procedure, the change system X1 and the nozzle D1 ensure in a mechanical manner that the nozzle D1 can be fixed only in an angularly correct alignment.

The change system X1 comprises a receptacle 1.1 for receiving the fastening base B1 of the nozzle D1 in an accurately fitting manner free of clearance, a rotating lock 2 and a housing element 3.

An alignment feature 3.1 is formed on the housing element 3 for the angularly correct, mechanical alignment of the nozzle D1. The alignment feature A1 of the nozzle D1 and the alignment feature 3.1 of the change system X1 are designed in a complementary manner.

A rotationally asymmetrical inner geometry which is non-circular in portions and has a linear or planar alignment portion 3.1 serves as the alignment feature 3.1 of the change system X1 for the angularly correct, mechanical alignment of the nozzle D1. The inner geometry is formed such that the nozzle D1 can be supplied to the change system X1 for fixing purposes only in an angularly correct alignment, whereas the nozzle D1 is blocked in an incorrect alignment.

Furthermore, the change system X1 comprises three fastening elements 4 (FIGS. 4 to 6) for holding the nozzle D1. The fastening elements 4 are used for engaging with the holding feature H1 of the nozzle D1 and are spaced apart from one another in the circumferential direction of the receptacle 1.1.

The fastening elements 4 are designed as balls and are inserted into three openings L in the wall W of the receptacle 1.1 inwards and outwards, in particular so as to be substantially radially displaceable.

The fastening elements 4 serve to fix the nozzle D1 in the axial direction, whereas the alignment feature 3.1 serve to fix the nozzle D1 in the circumferential direction.

The rotating lock 2 comprises a clamping ring 2.2 which has a profiled inner clamping contour 2.1 for moving the balls 4 inwards and outwards and surrounds the wall W of the receptacle 1.1. The rotating lock 2 comprises two rotating arms 2.3 which protrude radially from the clamping ring 2.2 and are each provided with a rotating flange 2.4.

The change system X1 is designed such that a rotational movement of the rotating lock 2 of less than 45° is sufficient to bring the nozzle D1 to a fixed state or a released state.

FIG. 2 also shows an application block (application head) 10 which is mounted on a lance rotatable about its longitudinal axis (FIG. 15) and constitutes a so-called 3D gun. The receptacle 1.1 and the housing element 3 are fixedly mounted on the application head 10.

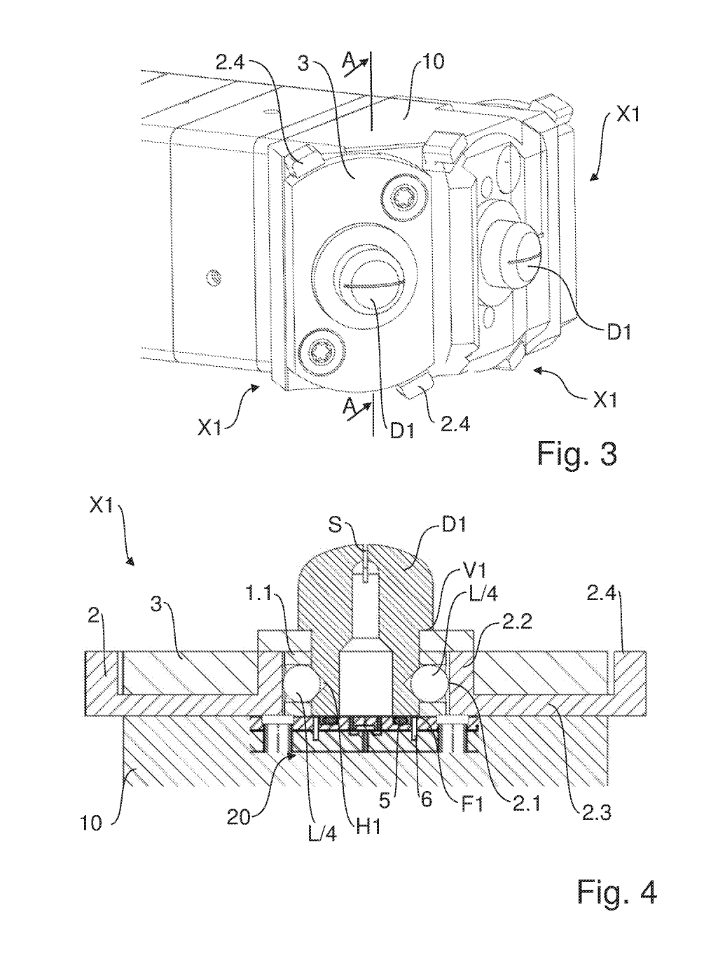

FIG. 3 shows the nozzle D1 and the change system X1 of FIG. 2 in a mounted state.

Three change systems X1 with three nozzles D1 are mounted on the application head 10. The nozzles D1 are oriented in different application directions, specifically 0°, 45° and 90°.

FIG. 4 shows a sectional view according to line A-A of FIG. 3.

FIG. 4 shows the nozzle D1 in a fixed state. The balls 4 in the openings L are pressed by the inner clamping contour 2.1 of the rotating lock 2 inwardly against the conical holding recesses H1 of the nozzle D1 which taper into the nozzle interior, whereby, on the one hand, the nozzle D1 is fixed in a form-fitting manner and, on the other hand, in FIG. 4 said nozzle is pressed axially downwards against an elastic sealing element 5 and a plurality of spring elements 6. If the fixing of the nozzle D1 is released, the sealing element 5 and the spring elements 6 press the nozzle D1 at least slightly outwards, which facilitates the procedure of removing the nozzle D1.

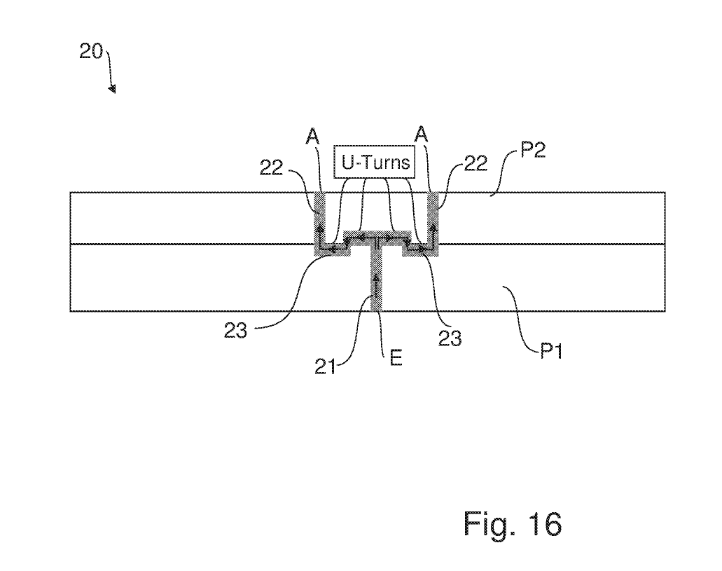

FIG. 4 also shows a pressure reducer 20 which, in terms of fluid engineering, is arranged directly upstream of the nozzle D1 and is integrated into the application head 10, so that it terminates flush with the outer surface of the application head 10. The pressure reducer 20 is described in greater detail with reference to FIG. 16.

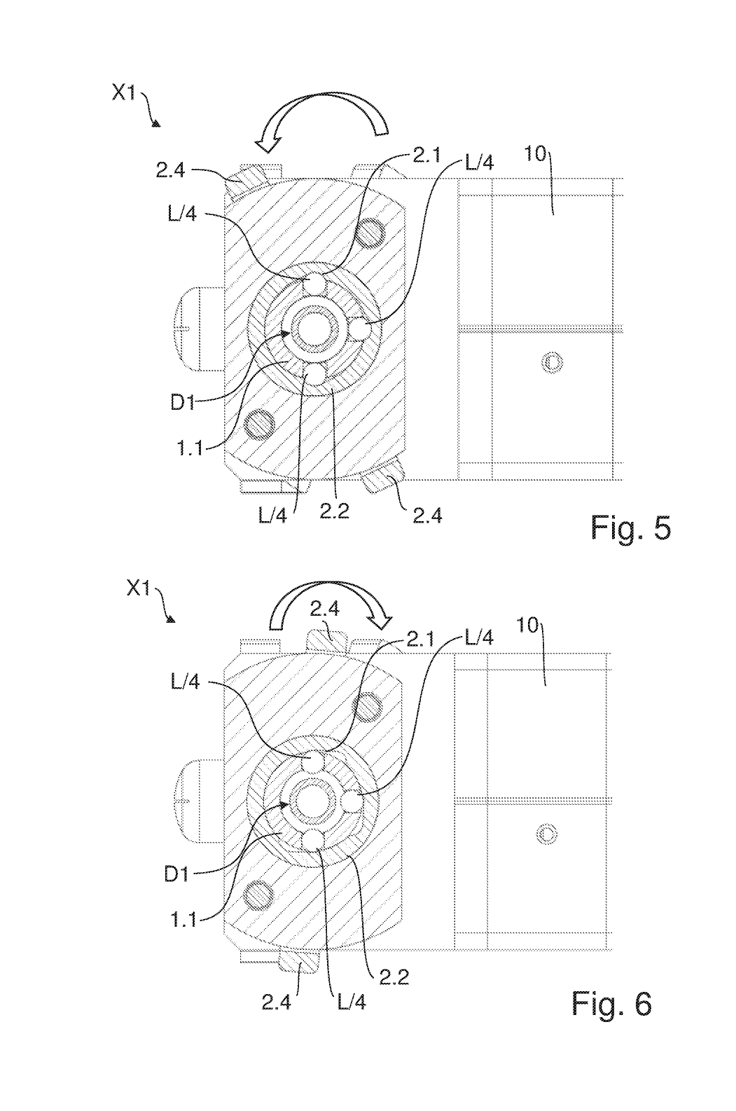

FIG. 5 shows a sectional view of the change system X1 of FIGS. 2 to 4 in an open state, so that the nozzle D1 can be removed.

FIG. 5 shows that the profiled inner clamping contour 2.1 of the rotating lock 2 has a free space for the balls 4, into which the balls 4 can be displaced in order to be able to remove the nozzle D1. The balls 4 are pushed into the free space of the inner clamping contour 2.1 by pulling out the nozzle D1.

FIG. 6 shows a sectional view of the change system X1 of FIGS. 2 to 5 in a locked state, so that the nozzle D1 is fixed.

FIG. 6 shows that the profiled inner clamping contour 2.1 of the rotating lock 2 presses the balls 4 against the nozzle D1 and the nozzle D1 is thereby fixed. In the fixed state, the balls 4 are displaced inwards. The inner clamping contour 2.1 is formed such that the rotating lock 2 and therefore the balls 4 remain in a self-locking manner in the fixing position for fixing the nozzle D1.

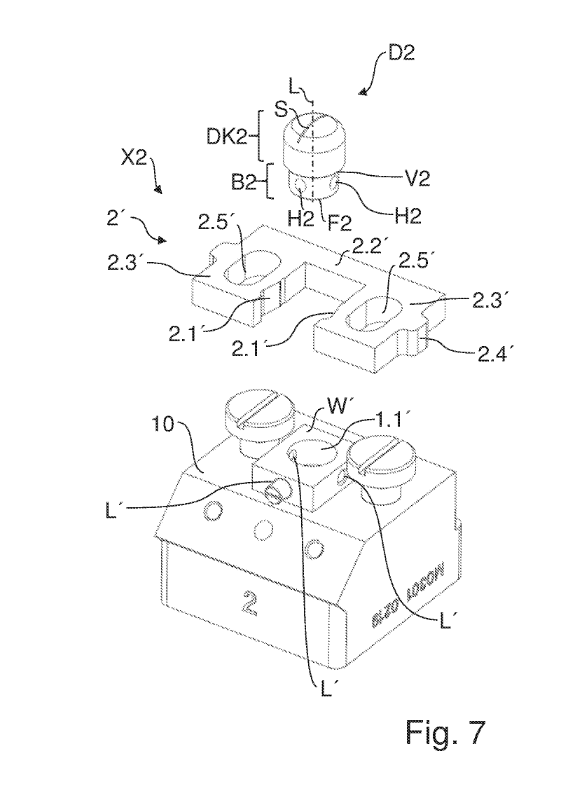

FIG. 7 shows a perspective view of an interchangeable nozzle D2 according to another implementation of the present disclosure and a change system X2 according to another implementation of the present disclosure.

The nozzle D2 comprises a nozzle body having an alignment feature H2 for the angularly correct, mechanical alignment of the nozzle D2 on the change system X2. The alignment feature H2 comprises three holding recesses H2 which are spaced apart from one another in the circumferential direction of the nozzle D2 and of which two can be seen in FIG. 7. The holding recesses H2 permit fixing only in an angularly correct alignment of the nozzle D2 and are used at the same time to releasably hold the nozzle D2 on the change system X2. Therefore, the alignment feature H2 is used at the same time as a holding feature H2 for releasably holding the nozzle D2 on the change system X2. It follows from this that within the scope of the present disclosure the holding feature and the alignment feature of the nozzle can be two mutually separate means or can be the same means.

The three holding recesses H2 are designed in a conical manner and taper into the nozzle interior, so that a non-axial, in particular substantially radial loading causes an axial displacement of the nozzle D2.

The nozzle D2 comprises a nozzle head DK2 and a fastening base B2. The nozzle head DK2 is broader than the fastening base B2 and has in particular a larger outer diameter than the fastening base B2. Between the nozzle head DK2 and the fastening base B2, the nozzle body has a step offset V2 which can serve for abutment on the change system X2.

The holding recesses H2 are formed on the fastening base B2 of the nozzle D2, whereas the slot-shaped nozzle outlet opening S is arranged on the nozzle head DK2.

An end surface F2 of the fastening base B2 comprises, like the end surface F1 of the nozzle D1, a nozzle inlet opening and serves for sealing abutment against the application head 10.

FIG. 7 also shows a change system X2 associated with the nozzle D2. The change system X2 is described hereinafter with reference to FIGS. 7 to 10.

The change system X2 is designed as a quick-change push system and thus renders it possible for the nozzle D2 to be interchangeable without the need for a screwdriver or other releasing tool and without the need for removing a part other than the nozzle D2. A pushing movement of e.g. less than 3 cm is sufficient to fix or release the nozzle D2. In spite of the rapid and simple change procedure, the change system X2 ensures that the nozzle D2 can be fixed only in an angularly correct alignment.

The change system X2 comprises a pusher 2′ and a receptacle 1.1′ having a cylindrical inner contour for receiving the fastening base B2 of the nozzle D2 in an accurately fitting manner free of clearance.

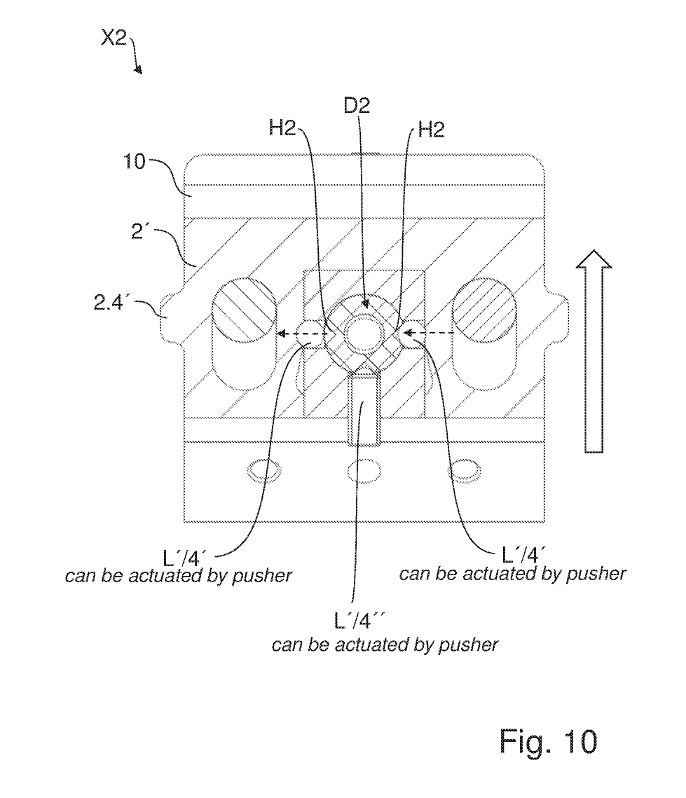

The change system X2 comprises an alignment feature 4′, 4″ having three fastening elements 4′, 4″ (FIGS. 9 and 10) which, on the one hand, serve for the angularly correct, mechanical alignment of the nozzle D2 and, on the other hand, for releasably holding the nozzle D2. The fastening elements 4′, 4″ of the change system X2 and the holding recesses H2 of the nozzle 2 are designed in a complementary manner.

The fastening elements 4, 4″ are spaced apart from one another in the circumferential direction of the receptacle 1.1′, so that they allow the nozzle D2 to be fixed only in the angularly correct alignment of the nozzle D2. The fastening elements 4′, 4″ serve for releasably holding the nozzle D2 (fixing in the axial direction and circumferential direction) and at the same time as an alignment feature 4′, 4″ for the nozzle D2. It follows from this that within the scope of the present disclosure the fastening elements and the alignment feature of the change system can be mutually separate means or can be the same means.

The three fastening elements 4′, 4″ are inserted inwards and outwards, in some implementations, so as to be substantially radially displaceable, into three openings L′ of the wall W′ of the receptacle 1′1.

The pusher 2′ comprises two arm portions 2.3′ which are connected to one another via a web portion 2.2′ and thus constitutes a substantially U-shaped, two-dimensional part, but can also be designed with a closed cross-sectional shape.

The inner sides of the arm portions 2.3′ are provided with a profiled inner clamping contour 2.1′ for moving two fastening elements 4′ inwards and outwards in order to bring the nozzle D2 to a fixed state or a released state. The third fastening element 4″ cannot be actuated by the inner clamping contour 2.1′ but instead can be prestressed e.g. with a spring in order to releasably fix the nozzle D2.

Furthermore, the arm portions 2.3 are provided with long holes 2.5′ for fastening and guiding the pusher 2′ and pushing flanges 2.4′ for displacing the pusher 2′.

The wall W′ or in general the receptacle 1.1′ comprises a square or rectangular outer contour which is received in an accurately fitting, form-fitting manner between the arm portions 2.3′, which means that the change system X2 is constructed relatively flatly.

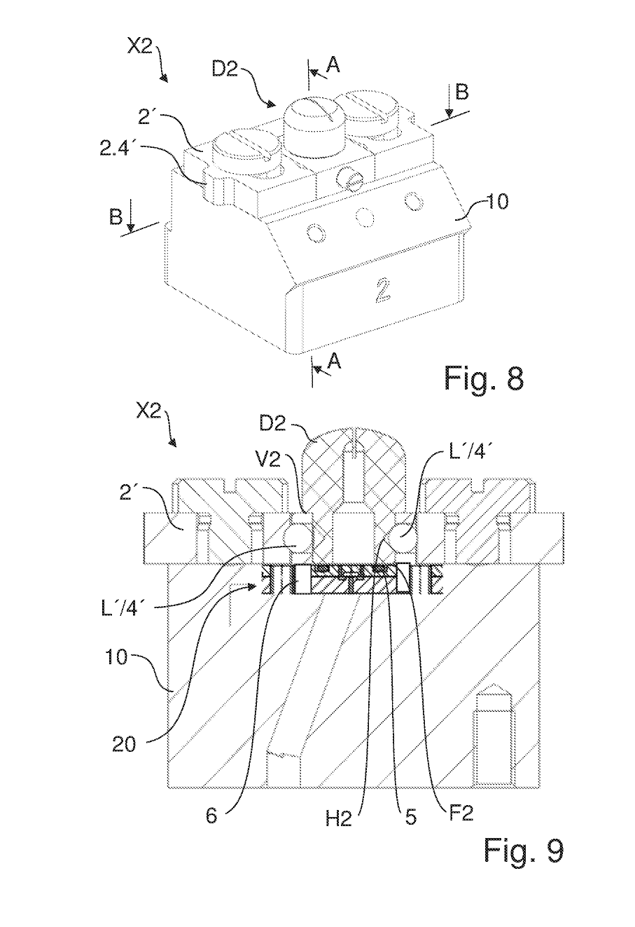

FIG. 9 shows a sectional view according to line A-A of FIG. 8, for illustration purposes in a released state on the left-hand side and in a fixed state on the right-hand side.

The change system X2 functions in a similar manner to the change system X1, but is based on a pushing movement.

The two fastening elements 4′ which are arranged so as to be able to be actuated with the pusher 2′ and to be displaceable in the wall 1.1′ are pressed by the inner clamping contour 2.1′ of the pusher 2′ inwardly against two conical holding recesses H2 of the nozzle D2 which taper into the nozzle interior, whereby, on the one hand, the nozzle D2 is fixed in a form-fitting manner and, on the other hand, in FIG. 9 said nozzle is pressed axially downwards against the elastic sealing element 5 and a plurality of spring elements 6. Moreover, the third fastening element 4″ which is arranged so as to be displaceable in the wall 1.1′ presses against a conical holding recess H2 of the nozzle D2 which tapers into the nozzle interior, whereby, on the one hand, the nozzle D2 is likewise fixed in a form-fitting manner and, on the other hand, in FIG. 9 said nozzle is pressed axially downwards against the elastic sealing element 5 and a plurality of spring elements 6.

If the pusher 2′ is displaced in order to release the nozzle D2, the profiled inner clamping contour 2.1′ of the pusher 2′ provides a free space for the fastening elements 4′ which can be actuated with the pusher 2′ and into which the two fastening elements 4′ can be displaced in order to be able to remove the nozzle D2. Then, the nozzle D2 can be removed against the spring force of the third fastening element 4″, whereby at the same time the fastening elements 4′ are pushed into the free space of the inner clamping contour 2.1′.

FIG. 10 shows a sectional view of the change system X2 of FIGS. 8 and 9, for illustration purposes in the fixed state on the right-hand side and in the released state on the left-hand side.

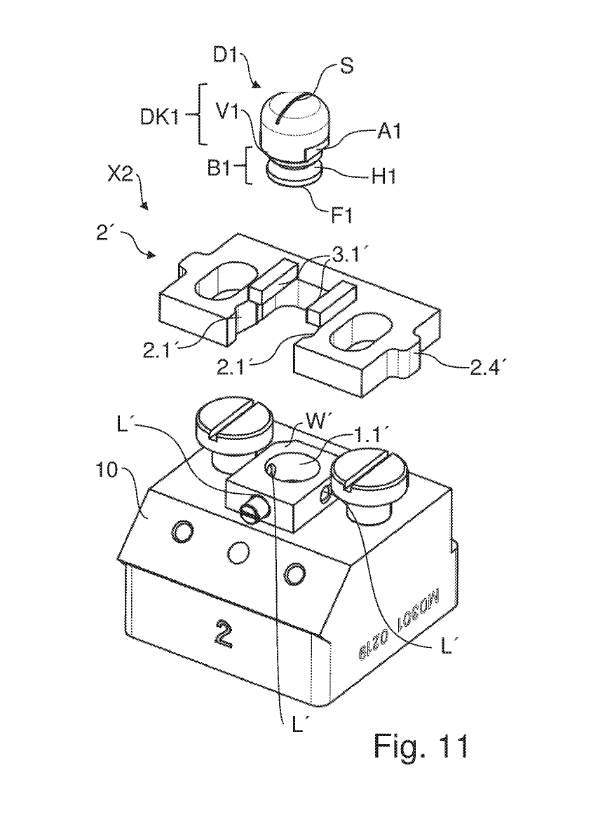

FIG. 11 shows a perspective exploded view of an interchangeable nozzle D1 and a change system X2 according to one implementation of the present disclosure which corresponds largely to the change system X2 of FIGS. 7 to 10.

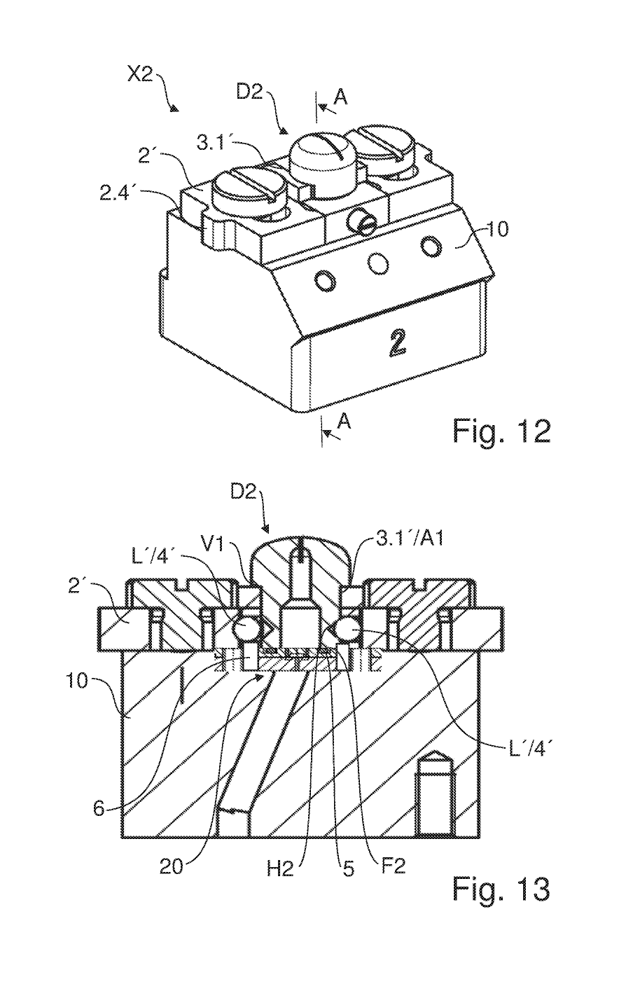

FIG. 12 shows the nozzle D2 and the change system X2 of FIG. 11 in a mounted state, whereas FIG. 13 shows a sectional view according to line A-A of FIG. 12.

A characteristic of the change system X2 shown in FIGS. 11 to 13 is that the pusher 2′ has an alignment feature 3.1′ for the angularly correct, mechanical alignment of the nozzle D2. The alignment feature 3.1′ is designed as a planar or linear alignment portion of an inner geometry. The alignment portion 3.1′ ensures that the nozzle D2 can be supplied to the change system X2 for fixing purposes only in an angularly correct alignment. Otherwise, the change system X2 of FIGS. 11 to 13 functions like the change system X2 described with reference to FIGS. 7 to 10.

In some implementations, the change systems X1 and X2 are characterised not only by their quick-change and alignment functions but also by their very flat construction. The change systems X1 and X2 can have a structural height of e.g. less than 4 cm, less than 3 cm or even less than 2 cm. This is made possible in particular by virtue of the fact that the individual components are designed to be relatively flat and are not joined one on top of the other but rather are joined one inside the other.

The change systems X1 and X2 are also characterised by the fact that they are designed both for changes which are automatic and changes which are manual (by hand).

It should be noted once again that the inner clamping contour 2.1, 2.1′ is formed in a profiled manner such that a self-locking nozzle fixing position can be achieved.

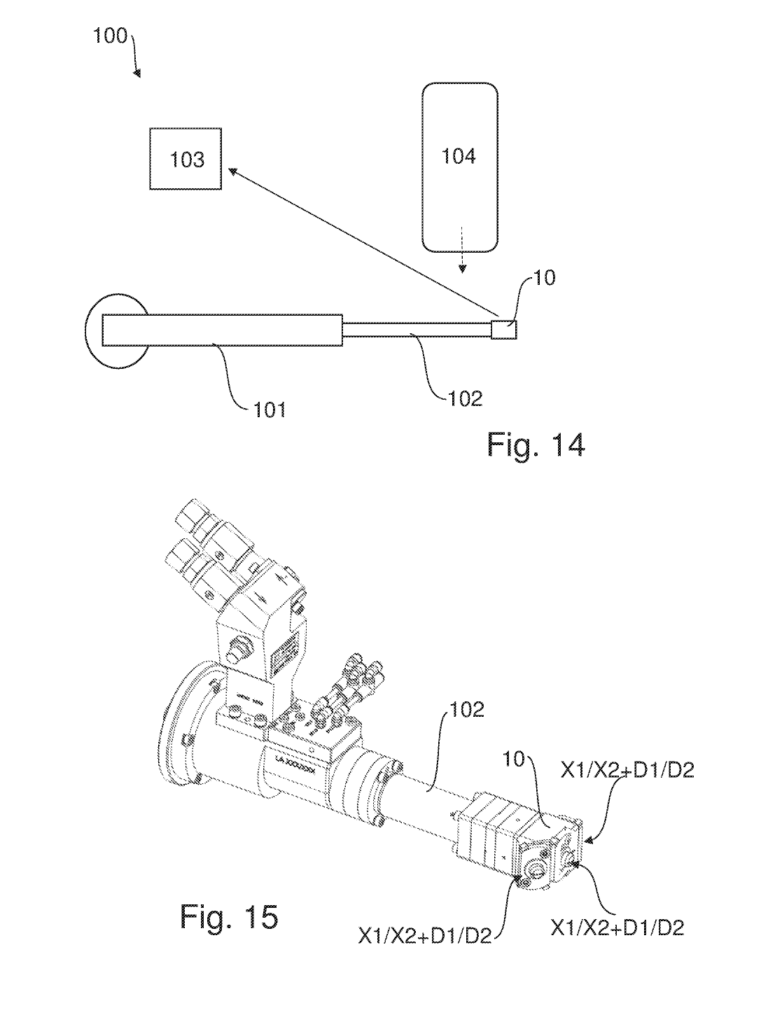

FIG. 14 shows a schematic view of an application system 100 according to one implementation of the present disclosure. The application system 100 is used in particular for applying sealing material to produce a seam seal on a motor vehicle body 104.

The application system 100 comprises an application head 10 on which at least two change systems X1 and/or X2 are mounted, as disclosed herein, and a robot 101, e.g. a multi-axis articulated arm robot, having a lance 102 which is rotatable about its longitudinal axis and supports the application head 10 together with the change systems X1/X2. The change systems X1/X2 serve for fastening nozzles D1 and/or D2, as disclosed herein. The lance 102 is shown in greater detail in FIG. 15.

Furthermore, the application system 100 comprises a nozzle change station 103 within reach of the robot 101. The nozzle change station 103 supports a plurality of nozzles D1/D2, as disclosed herein. The robot 101 is configured such that it guides the change systems X1/X2 to the nozzle change station 103 for automatically changing the nozzles D1/D2, which is shown schematically by the continuous arrow in FIG. 14. Therefore, the nozzles D1/D2 are not changed manually but instead automatically by the robot 101 and the nozzle change station 103.

The nozzle change station 103 can be equipped with an automatic nozzle cleaning device for cleaning the nozzles D1/D2.

FIG. 15 shows a lance 102 which is rotatable about its longitudinal axis and has an application head 10 with three nozzles D1/D2, which are oriented in different application directions, together with an associated change system X1/X2.

FIG. 16 shows a schematic sectional view of a pressure reducer 20 according to one implementation of the present disclosure.

The pressure reducer 20 comprises a line system for the application agent. The line system comprises an inlet line 21 having an application agent inlet E and two outlet lines 22 having two application agent outlets A which in an expedient manner serve to issue directly into the nozzle inlet opening of the nozzle D1/D2 (FIGS. 4, 9, 13).

The inlet line 21 is connected to the two outlet lines 22 via two branch lines 23, so that the application agent is deflected several times between the application agent inlet E and one application agent outlet A, in some implementations, via at least two U-turns, and the application agent is deflected several times between the application agent inlet E and the other application agent outlet A, in some implementations, via at least two U-turns.

As a result, the pressure reducer 20 can reduce e.g. about 30 to 50 bar pressure and thus renders it possible in particular for high-viscous but also low-viscous application material to be processed with the aid of a pressure regulator. In the case of more than one nozzle, the e.g. sealing nozzle and the protective nozzle.

Without the pressure reducer 20, 10 ccm/s of application material flows at a control pressure of e.g. 0.5 bar.

With the pressure reducer 20, only 1 ccm/s of material flows at a control pressure of e.g. 0.5 bar.

It is a characteristic that the pressure reducer 20 is integrated into the application head 10 in a releasable manner and therefore does not protrude from the application head 10, so that a TCP (Tool Centre Point) displacement does not occur (FIGS. 4, 9, 13). The outer surface of the pressure reducer 20 is formed, in some implementations, flush with the outer surface of the application head 10.

The pressure reducer 20 is constructed from two, in some implementations, separate plate parts P1 and P2, which makes it easier to incorporate the line system. It is only used if required.

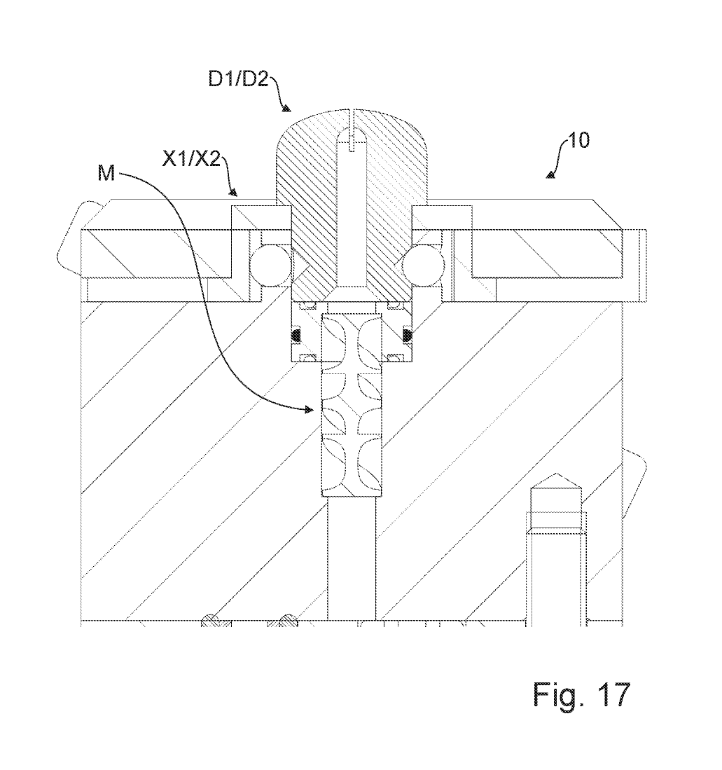

FIG. 17 shows a nozzle D1/D2 having a mixer M in the application head 10 according to one implementation of the present disclosure. The mixer M is integrated in particular into an application agent line in the application head 10 or is arranged on the outlet end thereof. The mixer M ensures a laminar flow of the application agent towards the nozzle D1/D2.

The present disclosure is not limited to the above-described exemplary implementations. Rather, a multiplicity of variants and modifications are possible which likewise make use of the concepts herein.

1.-38. (canceled)

39. A nozzle for applying an application agent onto a component and for fastening to a change system, the nozzle comprising:
a nozzle body;
an alignment feature defined in the nozzle body, the alignment feature configured for a mechanical engagement with the change system at a predetermined angular position;
at least one holding recess defined in an outer surface of the nozzle body, the at least one holding recess configured for a releasable engagement with the change system.

40. The nozzle of claim 39, wherein the alignment feature includes an outer shape of the nozzle body.

41. The nozzle of claim 40, wherein the outer shape of the nozzle body includes one of a linear region and a planar region.

42. The nozzle of claim 39, wherein the at least one holding recess tapers in a direction of an interior of the nozzle.

43. The nozzle of claim 42, wherein the at least one holding recess is a groove and extends at least partially around the nozzle body.

44. The nozzle of claim 39, wherein the alignment feature includes the at least one holding recess and at least one additional holding recess circumferentially spaced apart on the nozzle body.

45. The nozzle of claim 39, wherein the nozzle body has a fastening base with a centring pin configuration and an at least partially circular outer contour, and at least one of the alignment feature and the at least one holding recess is disposed on the fastening base.

46. The nozzle of claim 45, wherein the nozzle body has a nozzle head broader than the fastening base.

47. The nozzle of claim 39, wherein the nozzle is a slot nozzle configured for producing seam seals on motor vehicle bodies.

48. A change system for interchangeable nozzles comprising:
a nozzle including a nozzle body and a first alignment feature defined in the nozzle body, the nozzle further including at least one holding recess defined in an outer surface of the nozzle body,
a receptacle having a cylindrical inner contour for receiving the fastening base of the nozzle in a mechanical engagement at a predetermined angular position, the receptacle including a second alignment feature complementary to the first alignment feature of the nozzle, the second alignment feature configured to inhibit engagement of the nozzle and the receptacle outside of the predetermined angular position, the receptacle including at least one fastening element configured to engage the at least one holding recess in a releasable engagement.

49. The change system of claim 48, wherein the first and second alignment features each include at least one of a linear region and a planar region.

50. The change system of claim 48, wherein the second alignment feature includes at least two displaceable fastening elements circumferentially spaced apart from one another.

51. The change system of claim 48, wherein the at least one fastening element is disposed an opening of a wall of the receptacle.

52. The change system of claim 51, wherein the wall of the receptacle has at least two openings which are circumferentially spaced apart from one another, and wherein the system further comprises at least two fastening element, each inserted into one of the at least two openings.

53. The change system of claim 48, comprising a movable actuating element having a profiled inner clamping contour configured for acting upon and releasing the at least one fastening element to one of fix and release the nozzle.

54. The change system of claim 53, wherein the actuating element is coupled to the at least one fastening element and is configured to press the at least one fastening element laterally against the nozzle.

55. The change system of claim 54, wherein the actuating element is a rotating lock, and
the rotating lock has a clamping ring defining the inner clamping contour.

56. The change system of claim 55, wherein the rotating lock has at least one rotating arm which protrudes from the clamping ring and is provided with a rotating flange.

57. The change system of claim 48, further comprising an elastic sealing element, against which the nozzle is pressed axially by the at least one fastening element.

58. The change system of claim 48, further comprising a nozzle change station for a plurality of nozzles, wherein the nozzle change station has a nozzle removal section configured for automatically removing an attached nozzle from the change system and has a nozzle transfer section configured for automatically mounting one of the plurality of nozzles on the change system.
